(19) United States
(12) Patent Application Publication
(10) Pub. No.: US 2008/0170720 A1
(43) Pub. Date: Jul. 17, 2008

(54) Amplifier apparatus and method

(76) Inventor: Tahir Rashid, Berkshire (GB)

Correspondence Address: DICKSTEIN SHAPIRO LLP, 1825 EYE STREET NW, Washington, DC, 20006-5403, US

(21) Appl. No.: 11/785,705

(22) Filed: Apr. 19, 2007

(30) Foreign Application Priority Data
Aug. 31, 2006 (GB) 0617201.9

(51) Int. Cl. H04B 15/00

(52) U.S. Cl. 381/94.5

(57) ABSTRACT

An amplifier start-up apparatus for reducing transient signals in an audio circuit including a reference voltage generator circuit for generating a reference voltage. The reference voltage generator circuit includes a capacitor for maintaining the reference voltage at a desired level. The amplifier start-up apparatus includes a charging control circuit for controlling the operation of the reference voltage generator circuit during power-up. The charging control circuit includes a switching device for controlling the charging of the capacitor, wherein the switching device is controlled by a pulsed signal. The pulsed signal is a pulse width modulated (PWM) signal in which the pulse width is proportional to the voltage level of the reference voltage being generated. The amplifier start-up apparatus can further be adapted to include a discharging control circuit for controlling the discharge of the capacitor during a power-down operation.

### RELATED APPLICATIONS

The present application is related to co-pending application Attorney Docket No. H0222.0003/P003, which has been filed concurrently herewith.

### BACKGROUND OF THE INVENTION

1. Field of the Invention

The invention relates to an amplifier apparatus and method for reducing unwanted transient signals, and in particular to an amplifier start-up apparatus and method for reducing unwanted audible signals generated by transient signals in an audio amplifier circuit.

2. Description of the Related Art

“Click” and “pop” are terms used to describe unwanted audio-band transient signals that are heard in a headphone or a speaker when an audio amplifier is enabled or disabled.

In portable audio applications power consumption is a key issue, which means that circuit components, such as audio amplifiers, are often disabled or powered down when not required. This can lead to unwanted audio-band transient signals being produced, both when an audio amplifier is powered down or placed in a sleep or hibernation mode, and when an audio amplifier is powered up or enabled from a sleep or hibernation mode. Similar problems can also arise in other non-portable applications.

Click and pop problems are particularly problematic in single supply amplifiers that have to charge to a certain defined voltage during power up.

FIG. 1 shows a known audio amplifier circuit 1 for driving a load 2, for example a headphone or a speaker, coupled to an output terminal 3. An output amplifier 5 receives an audio signal at a first input terminal 7 from an audio source, such as a mixer 9. It will be appreciated that the mixer 9 receives an audio signal from a DAC (not shown) or other signal source. The amplifier 5 also receives a reference voltage V_{MID} at a second input terminal 11. In order for the output signal of the amplifier to achieve maximum swing, either side of its quiescent output voltage, this quiescent voltage is set midway between the supply voltages VDD and ground (GND). The quiescent voltage is set by an applied reference voltage V_{MID}, equal to VDD/2.

The reference voltage V_{MID} is produced by a reference voltage generator circuit 13. As will be described in greater detail below, a transient signal may be produced when the reference voltage generator circuit 13 is powered up, thereby causing an unwanted “pop” being transmitted to the headphone or speaker. Transient signals can also be produced when powering down the reference voltage generator circuit. It is noted that the present application is concerned with reducing or eliminating the effects of unwanted transient signals during power up, or during both power up and power down. Co-pending application ID-06-018 is concerned with reducing or eliminating the effects of unwanted transient signals during power down only.

It is noted that control logic 10 is provided for controlling the operation of the output amplifier 5 during power up, power down, and mute operations. For example, the control logic 10 provides a control signal S₁ for controlling the reference generator circuit 13, a control signal S₂ for controlling the amplifier 5 (for example when performing a mute operation), and a control signal S₃ for controlling a buffer circuit 14. The buffer circuit 14 buffers the reference voltage V_{MID} received from the reference voltage generator circuit 13. It is noted that the buffer circuit 14 is not essential to the functional operation of the amplifier circuit.

Referring to the flow chart of FIG. 2, a brief description of a typical power up sequence is provided. A similar sequence of operations will occur when the amplifier circuit is re-enabled (i.e. enabled) after a period of being disabled (i.e. after hibernation). On initial application of power, step 201, the signal path from input to output is in a mute state, i.e. in a state where the output is unaffected by the input signal, for example by interrupting the signal path using a switch. The amplifier 5 is in a disabled state, i.e. not driving its output. The reference voltage generator circuit 13 that produces the reference voltage V_{MID} is then enabled, step 203. This is performed, for example, by closing the switch 131 of FIG. 1. There is a delay while the reference voltage stabilises, and while the decoupling and AC coupling capacitors charge, step 205. This delay can take approximately 1 second depending on the total capacitive load. It is noted that the AC coupling capacitor 15 may be charged, for example, using a bypass signal path having a bypass switch 17 as shown in FIG. 1. This allows the reference voltage V_{MID} to bypass the disabled amplifier 5 and charge the AC coupling capacitor 15 to V_{MID}.

Once the reference voltage V_{MID} has settled the output amplifier 5 is enabled, step 207. The amplifier 5 is then un-muted, step 209, thereby connecting the amplified audio signal to the output terminal 3.

Since the reference voltage V_{MID} is connected to the load 2, via bypass switch 17, when the reference voltage generator circuit 13 is being enabled a “pop” is produced due to a slope discontinuity, i.e. rapid deviation or change, in the rate of change of the reference voltage V_{MID} across the capacitor 135. The slope discontinuity produces audible signal components that propagate through to capacitor 15 and onto the load 2, thereby causing an audible click or pop.

FIG. 3 shows a typical reference voltage generator circuit 13 for producing the reference voltage V_{MID}. The reference voltage V_{MID} can be produced using a potential divider circuit, for example, that comprises resistive elements 137 and 139. If the voltage level of the reference voltage is chosen to be VDD/2, then the resistive elements 137 and 139 will have equal values. It will be appreciated that the resistive elements 137 and 139 would have different values if a different reference voltage was required. A decoupling capacitor 135 is connected across resistive element 139. It is noted that, in the case of an integrated circuit arrangement, the decoupling capacitor 135 may be provided off-chip, if desired, and is used to decouple the V_{MID} node 133. A switch 131 is provided for enabling and disabling the reference voltage generator circuit 13 under control of the control signal S₁.

FIG. 4 shows the reference voltage V_{MID} at node 133 during power-up and power-down of the reference voltage generator circuit 13. Before the reference voltage generator circuit 13 is switched on at T_{ON}, the decoupling capacitor 135 is effectively short-circuited to ground via resistor 139. When the reference voltage generator circuit 13 is switched on at T_{ON}, this results in a rapid deviation or change in the reference voltage V_{MID} across the capacitor 135. As the decoupling capacitor 135 continues to charge, the rise in the voltage V_{MID} becomes more gradual until the desired reference voltage V_{MID} is reached. This slope discontinuity of the reference voltage V_{MID} at T_{ON} is what causes the audible pop.

As mentioned above, in addition to the power-up problem, the circuit of FIG. 1 also exhibits problems during power-down. When the switch 131 is used to disable the reference voltage generator circuit 13, the capacitor 135 is discharged through resistor 139. This results in another slope discontinuity in V_{MID} as shown in FIG. 4 at T_{OFF}. The slope discontinuity produces audible signal components that propagate through capacitor 15 and onto the load, and thus also causes an audible pop at T_{OFF}.

One method of avoiding these slope discontinuities would be to increase the value of resistor 139. However, an increased value of resistor 139 would lead to an unacceptably long charge or discharge time (e.g. 5 to 10 seconds), whereas the charge or discharge time is desired to be a few hundred milliseconds.

It is therefore an aim of the present invention to provide an amplifier start-up apparatus and method for reducing unwanted transient signals in an audio circuit.

### SUMMARY OF THE INVENTION

According to a first aspect of the invention, there is provided an amplifier start-up apparatus for reducing transient signals in an audio circuit comprising a reference voltage generator circuit for generating a reference voltage, the reference voltage generator circuit comprising a capacitor for maintaining the reference voltage at a desired level. The apparatus comprises a switching device connected between the capacitor and a supply voltage, and a charging control circuit for controlling the operation of the switching device during power-up. The charging control circuit comprises circuitry for providing a pulsed signal for controlling the switching device, and hence the rate at which the capacitor is charged.

According to another aspect of the present invention, there is provided a method of reducing transient signals in an amplifier start-up apparatus for an audio circuit comprising a reference voltage generator circuit for generating a reference voltage, the reference voltage generator circuit comprising a capacitor for maintaining the reference voltage at a desired level. The method comprises the steps of providing a switching device between the capacitor and a supply voltage, and controlling the operation of the switching device during power-up by providing a pulsed signal for controlling the switching device, and hence the rate at which the capacitor is charged.

According to further aspects of the invention, there are provided various systems employing the apparatus defined in the claims.

### BRIEF DESCRIPTION OF THE DRAWINGS

For a better understanding of the present invention, and to show more clearly how it may be carried into effect, reference will now be made, by way of example only, to the following drawings in which:

FIG. 1 shows an audio circuit according to the prior art;

FIG. 2 describes a typical power-up sequence for the circuit shown in FIG. 1;

FIG. 3 shows a reference voltage generator circuit according to the prior art;

FIG. 4 is a graph showing how the reference voltage generated by the circuit of FIG. 3 is formed during power-up and power-down operations;

FIG. 5 shows a reference voltage generator circuit having an amplifier start-up apparatus according to a first embodiment of the present invention;

FIGS. 6a and 6b show how the PWM signal 154 of FIG. 6b is formed using the saw-tooth waveform and V_{MID} signal of FIG. 6a during a power-up operation;

FIG. 7 is a graph showing the reference voltage during power-up in accordance with the present invention;

FIG. 8 shows a reference voltage generator circuit having an amplifier start-up apparatus according to a second embodiment of the present invention;

FIG. 9 is a graph showing how the charging control circuit of FIG. 8 is disabled during a second mode of operation;

FIG. 10 shows a reference voltage generator circuit having an amplifier start-up apparatus according to a third embodiment of the present invention;

FIG. 11 shows a reference voltage generator circuit having an amplifier power-down apparatus according to related application ID-06-018;

FIGS. 12a and 12b show how the PWM signal 184 of FIG. 12b is formed using the saw-tooth waveform and V_{MID} signal of FIG. 12a during a power-down operation;

FIG. 13 is a graph showing the reference voltage during power-down;

FIG. 14 shows a reference voltage generator circuit having a power-up and power-down apparatus according to a second aspect of the present invention;

FIG. 15 shows a reference voltage generator circuit having a power-up and power-down apparatus according to a third aspect of the present invention;

FIG. 16 shows an example of a typical application of the present invention;

FIG. 17 shows a further example of a typical application of the present invention;

FIG. 18 shows a further example of a typical application of the present invention; and

FIG. 19 shows a further example of a typical application of the present invention.

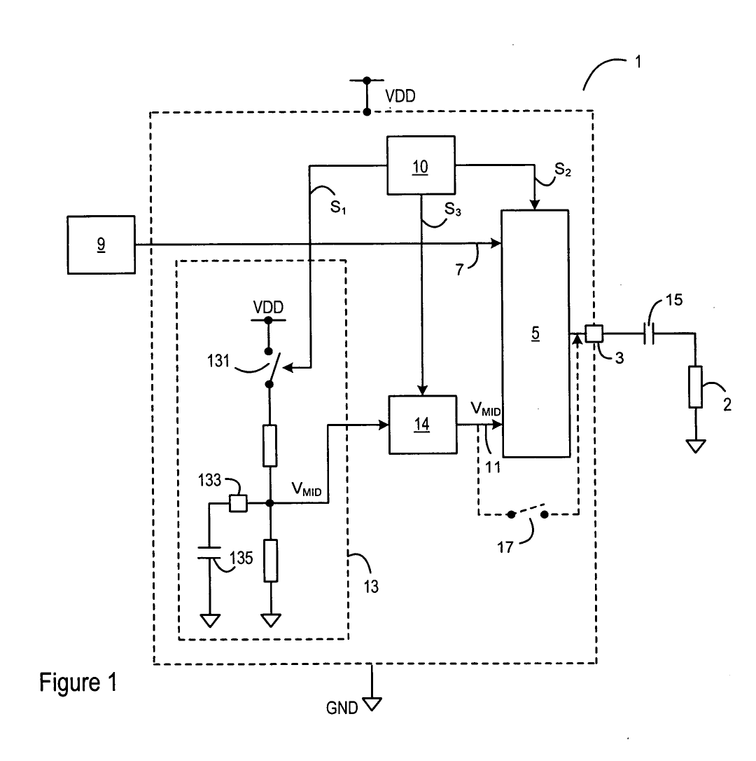

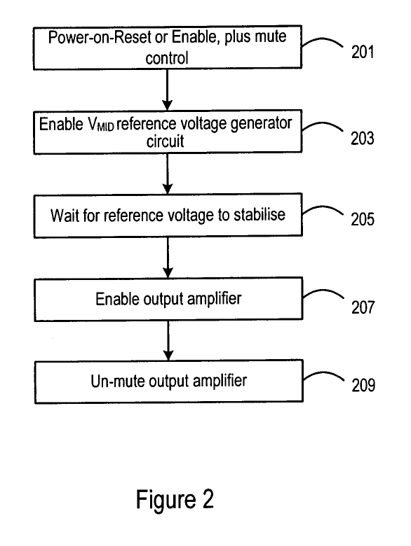

### DETAILED DESCRIPTION OF THE PREFERRED EMBODIMENTS

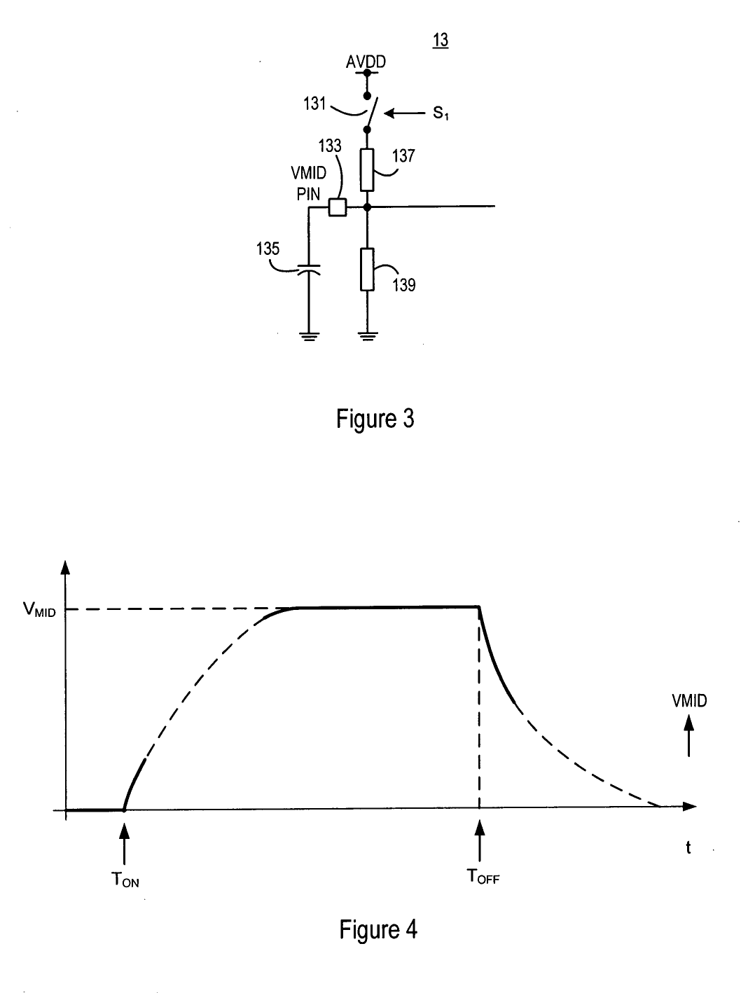

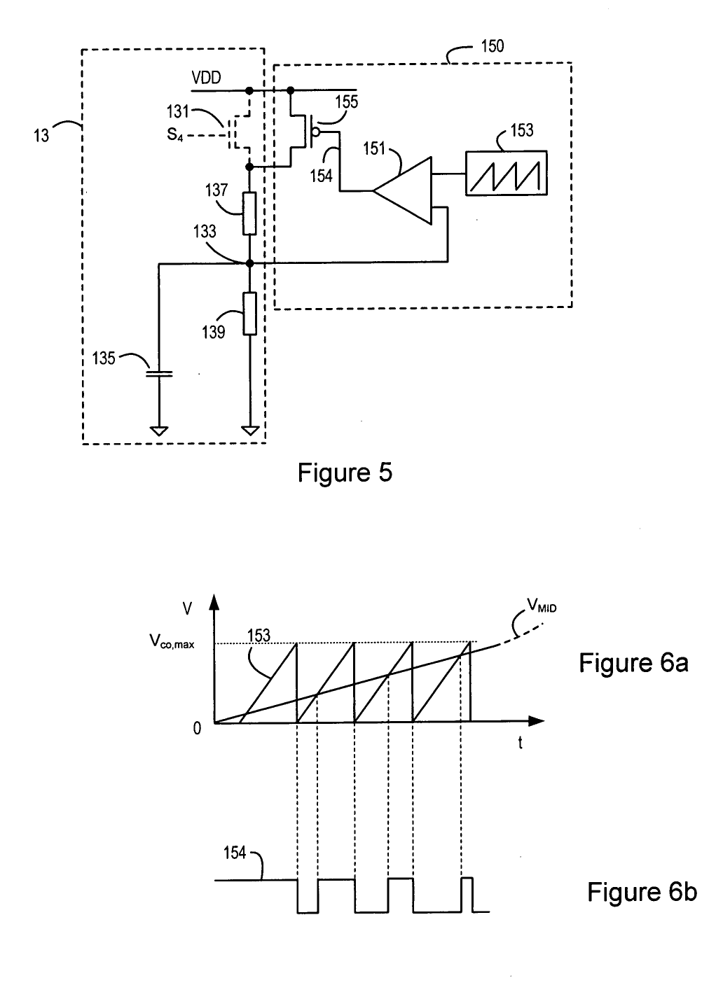

Referring to FIG. 5, there is shown an amplifier start-up apparatus according to a first embodiment of the present invention. In a similar manner to FIG. 3, a reference voltage generator circuit 13 for producing a reference voltage V_{MID} comprises a potential divider circuit comprising resistive elements 137 and 139. The resistive elements 137 and 139 can be chosen, for example, to provide a reference voltage that is mid-way between the supply rails of VDD and ground. A decoupling capacitor 135 is connected across resistive element 139. The decoupling capacitor 135 acts to maintain the reference voltage at a desired voltage level during operation. The decoupling capacitor 135 may be provided off-chip, if desired, and is used to decouple the V_{MID} node 133.

However, rather than using the switch 131 (for example an NMOS transistor) to enable the reference voltage generator circuit 13, the amplifier start-up apparatus comprises a charging control circuit 150 for powering up the reference voltage generator circuit in a controlled manner. According to the invention the charging control circuit 150 controls the rise of the reference voltage V_{MID} as will be described below.

The charging control circuit comprises a comparator 151 that is configured to receive a comparison waveform on a first input terminal, and the reference voltage being generated on a second input terminal. The comparison waveform is preferably a saw-tooth waveform received from a saw-tooth waveform generator 153. However, it will be appreciated that other suitable waveforms could be used, including other symmetrical or non-symmetrical waveforms that repetitively scan across the range of the anticipated input signal, provided such signals have at least one edge having a slew rate. Other such examples include sine-wave or triangular shaped waveforms.

The waveform generator 153 can be provided on-chip. Alternatively, the comparison waveform can be received from an external source. A typical frequency for the saw-tooth waveform is about 100 kHz, although it will be appreciated that other frequencies can also be used.

The comparator 151 produces an output signal 154 which is used to control a switching device, for example an PMOS transistor 155. It will be appreciated that other forms of switching device could be used, including NMOS and bipolar devices. The transistor 155 is connected between the resistor 137 and the supply voltage VDD, for controlling the flow of current to the capacitor 135.

FIGS. 6a and 6b are provided to illustrate the principles of operation of the charging control circuit 150. It will be appreciated that, in reality, the charging control circuit 150 will produce significantly more pulses than those shown in FIGS. 6a and 6b. The charging control circuit 150 of FIG. 5 is used to control the charging of the capacitor 135 as follows. The configuration of the comparator 151 is such that it produces narrow pulses in the output signal 154 for controlling the transistor 155 during the initial stages of power-up, i.e. when V_{MID} is low. It will be appreciated that a “pulse” corresponds to a period when the output signal 154 is low (i.e. because the output signal 154 is being used to drive a PMOS transistor 155). Each respective narrow pulse turns on the transistor 155 for a duration determined by the respective width of the pulse, thereby allowing current to flow in a controlled manner to the capacitor 135. As the voltage level of the reference voltage V_{MID} increases, this results in wider pulses being output from the comparator 151, thus resulting in the transistor 155 being turned on for longer periods of time. In other words, as the voltage V_{MID} begins to rise the output 154 of the comparator 151 will consist of wider pulses, which in turn means that the transistor 155 is switched on for longer periods of time, which results in the reference voltage V_{MID} rising more rapidly. This positive feedback arrangement provides an acceleration effect such that the reference voltage V_{MID} continues to rise.

It will be appreciated by a person skilled in the art that the connection of the inputs to the comparator 151 will depend on whether a PMOS or NMOS transistor is used as the switching device 155 (and also the configuration of the comparison waveform itself), and that other circuit components may therefore be required to provide a suitable pulsed signal for controlling the transistor 155 (for example the use of inverting buffers to provide the required signals).

As the reference voltage continues to rise, a point is reached when V_{MID} reaches a peak value V_{CO,max} (i.e. Vmid/2) of the comparison or saw-tooth waveform, at which point the comparator output becomes constant and transistor 155 is continuously turned hard-on. The charging of the capacitor 135 is then based on the RC time constant of the resistors 137, 139 and the capacitor 135.

Thus, from the above it will be appreciated that charging control circuit 150 operates according to two modes of operation. During a first period of operation the charging of the capacitor 135 is controlled via the positive feedback path comprising the output of the comparator 151, the transistor 155, the resistor 137 and the second input terminal of the comparator 151. During a second period of operation, (i.e. when the transistor 155 is turned hard-on), the charging of the capacitor 135 is controlled by the RC time constant of the reference voltage generator circuit.

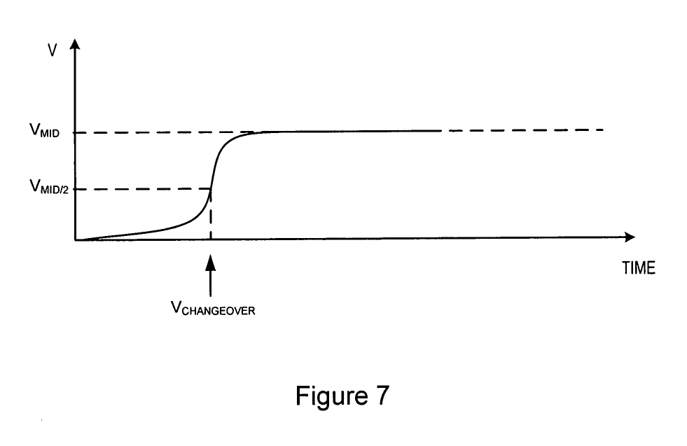

In the first period of operation, the average charging current will increase as the duty cycle of the switch increases, giving a V_{MID} waveform with increasing slope. This slope will saturate at a value dependent on the resistors 137 and 139 when the duty cycle reaches 100%. In the second period of operation, the slope of the V_{MID} waveform will start to decrease, as V_{MID} asymptotically approaches VDD/2, due to the RC time constant which is determined by resistors 137 and 139 and capacitor 135. Thus an S-shaped waveform is generated as illustrated in FIG. 7.

In other words, the slope discontinuity, or deviation, at T_{ON} is no longer exhibited and, instead, the reference voltage V_{MID} rises in a smoother and more controlled manner, thereby minimising or suppressing the high frequency components associated with the prior art waveform which causes “click” or “pop” effects on the output of the amplifier. After the initial gradual and smooth rise in the slope of the reference voltage V_{MID}, the reference voltage then rises more rapidly, followed by another gradual and smooth transition to its final value as the capacitor 135 completes its charging process.

It will therefore be appreciated that the embodiment of FIG. 5 has the advantage of reducing and preferably preventing unwanted audio-band signals caused by the slope discontinuity of V_{MID} from causing undesired “pop” sounds during initial power-up of the reference voltage generator circuit, while still allowing the reference voltage generator circuit to reach the desired reference voltage V_{MID} in a timely manner.

It is noted that other types of reference voltage generator circuits known to those skilled in the art could be used for generating the reference voltage, other than the illustrated potential divider circuit.

It is also noted that the circuit may be configured to assist with start-up when V_{MID} is at ground. Assuming the minimum voltage of the comparison waveform is also ground, the inputs to the comparator may never be of the correct polarity to turn on the switch 155, particularly if the comparator has an input offset voltage of one polarity. Thus the circuit might never start up. To avoid this, the comparator may be designed with a deliberate offset, larger than any anticipated random offset due to manufacturing component mismatches, but still small enough to give a small initial duty cycle and thus only a small initial transient. Alternatively a small current source (not illustrated) may be turned on to inject current into V_{MID} either directly or via resistor 137. The current source can be designed to deliver only a small fraction of the eventual resistor divider current, but enough to overcome any anticipated offset of the comparator and other similar effects.

Since power consumption is an increasingly important factor, especially in relation to portable audio devices such as portable music players, it will be appreciated that the charging control circuit 150 is preferably turned off after the initial power-up sequence in order to conserve power. Prior to the charging control circuit 150 being disabled, the transistor 131 can be turned on using control signal S₄, such that resistor 137 is tied to VDD and hence the voltage across capacitor 135 maintained. Therefore, in the second period of operation the comparator 151 and its positive feedback path can be disabled, and the transistor 131 used to maintain the charge on the capacitor 135.

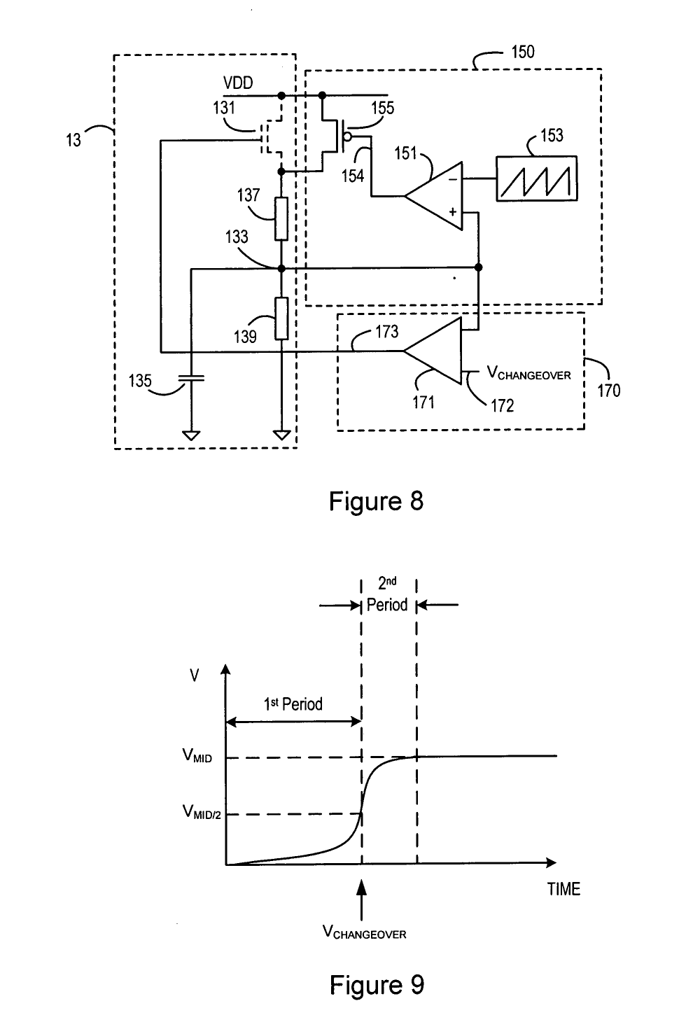

FIG. 8 shows a circuit arrangement according to another embodiment of the present invention, which provides a means of controlling switch 131.

In a similar manner to FIG. 5, the reference voltage generator circuit comprises a potential divider circuit comprising resistive elements 137 and 139. A decoupling capacitor 135 is connected across resistive element 139. The charging control circuit 150 comprises a comparator 151 configured in a positive feedback arrangement for controlling the current supplied to capacitor 135 during initial power-up.

As before, the comparator 151 is configured to receive a comparison waveform, for example a saw-tooth waveform, from a waveform generator 153 on a first input terminal, and the reference voltage being generated on a second input terminal. The comparator 151 produces an output signal 154 which is used to control a switch 155, for example an PMOS transistor. The transistor 155 is connected between the resistor 137 and the supply voltage VDD, for controlling the flow of current to the capacitor 135. As with FIG. 5, it is noted that the PMOS transistor 155 could be replaced by another suitable switching device, for example an NMOS or bipolar device.

According to the embodiment of FIG. 8, a changeover circuit 170 is provided for causing the current supplied to capacitor 135 to be charged via the switch 131 after V_{MID} has reached a predetermined threshold voltage (V_{CHANGEOVER}), thereby enabling the charging control circuit 150 to be disabled. In this way, the changeover circuitry comprises a dedicated switching device (i.e. the switch 131) for maintaining a charge on the capacitor when the charging control circuit is disabled during the second period.

The changeover circuit 170 comprises a comparator 171 for comparing the voltage level of the reference voltage V_{MID} with the threshold voltage 172 (V_{CHANGEOVER}). The threshold voltage 172 is chosen such that the switchover from the control circuit 150 to the transistor 131 occurs at a voltage level somewhere between ground and the desired reference voltage V_{MID}, and preferably midway between ground and V_{MID} (as shown in FIG. 9). Preferably the threshold voltage is set at or slightly above the value of V_{MID} at which the duty-cycle of operation of switch 155 reaches 100%, substantially equal to the peak V_{CO,max} of the comparison waveform. For example, the threshold voltage 172 for the comparator 171 can be set as V_{MID}/2 (i.e. VDD/4).

As can be seen from FIG. 9, the comparator 171 of FIG. 8 is arranged such that it causes a switchover at point V_{CHANGEOVER}, V_{CHANGEOVER} being a voltage level that is arranged along the rising slope of the reference voltage V_{MID}, and preferably around a mid-voltage point (VDD/4). In this way, any transient signals caused by the switchover from the charging control circuit 150 to the switch 131 will occur when the reference voltage V_{MID} is actually rising. As a result, unwanted transitions can be effectively masked at this point. In contrast, if the switchover was performed after fully charging the capacitor 135, i.e at a point when V_{MID} has settled, a new “pop” could occur during such a switchover. In other words, the charging control circuit used for preventing one “pop” could result in another “pop” being created at a different point in time. This embodiment minimises or prevents such a disadvantageous occurrence.

It will be appreciated that the comparator 171 of FIG. 8 could be replaced by other suitable circuit components, such as a logic stage comprising MOS transistors for performing the same function.

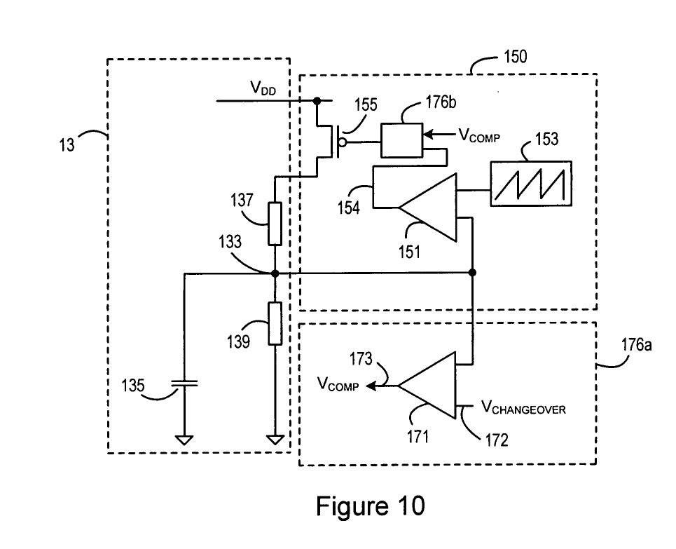

According to an alternative embodiment, as shown in FIG. 10, the transistor 131 of the reference voltage generator circuit 13 can be disposed of, and changeover circuitry 176a, 176b provided to control transistor 155. In particular, the transistor 155 can be controlled using changeover circuitry 176b which receives the normal output 154 from comparator 151, and the output signal 173 (V_{COMP}) from the comparator 171 of changeover circuitry 176a. As with FIG. 8, the comparator 171 receives the reference voltage V_{MID} on a first input and a threshold voltage 172 (V_{CHANGEOVER}) on a second input. The comparator is therefore configured to provide a switching signal when the reference voltage V_{MID} reaches a predetermined threshold, such as VDD/4. The changeover circuitry 176b is configured to keep switch 155 turned on after or while this signal is received. Depending on signal polarities, this could be a simple NOR gate for example. In this way, the comparator 151, comparison waveform generator 153 and associated circuitry are used to control the switch 155 during a first period of the power-up operation, with the comparator 171 and the changeover circuitry 176b being used to control transistor 155, keeping it switched on regardless of any output from comparator 151, during a second period of operation. In this manner, the comparator 151 and associated circuitry can be disabled during the second period of operation, such that only the comparator 171 and the changeover circuitry 176b consume power, rather than the entire components within the charging control circuit 150. Although not illustrated, 176b could be modified, as will be appreciated by those skilled in the art, to latch the output from comparator 171 once it has switched, thereby enabling the comparator 171 to be powered down.

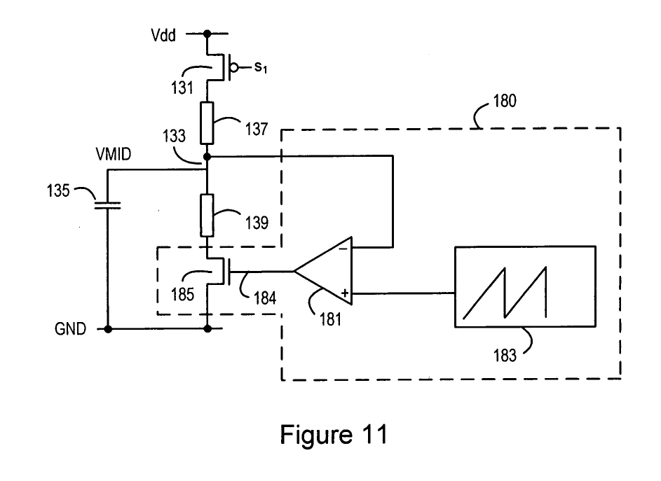

FIG. 11 describes a similar circuit arrangement to that disclosed in FIG. 5 above, but arranged to control the discharge of the reference voltage V_{MID} during a power-down operation, as also described in co-pending application ID-06-018.

In FIG. 11 a discharge control circuit 180 comprises a switching device 185, for example an NMOS transistor, for controlling the discharge of current from the capacitor 135 to ground during a power-down operation. As before, it will be appreciated that other switching devices could be used, such as PMOS or bipolar devices.

The switching transistor 185 is controlled by a comparator 181. The comparator 181 is connected to receive the reference voltage V_{MID} at a first input terminal (i.e. the reference voltage that is being controlled is provided as one input). The comparator 181 is connected to receive a comparison waveform, for example a saw-tooth waveform, at a second input terminal. The saw-tooth waveform is provided by a saw-tooth generator 183, which can be provided on-chip, or can be received from an external source. A typical frequency for the saw-tooth waveform is about 100 kHz, although it will be appreciated that other frequencies can also be used.

When the reference voltage generator circuit is in a powered-up state, and the capacitor 135 is in a charged state, the voltage V_{MID} at node 133 corresponds to the desired reference voltage, say VDD/2. When the circuit is to be powered-down or turned off, the discharge control circuit 180 controls the discharge of current from capacitor 135 in the following manner.

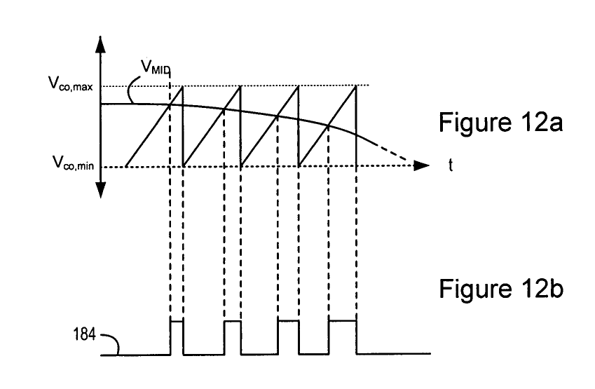

The saw-tooth signal is applied to the first input of the comparator 181, with the reference voltage V_{MID} applied to the second input terminal. The peak value V_{CO,max} of the comparison or saw-tooth waveform is set to V_{MID} or slightly higher. Since the voltage at node 133 will be high, i.e. the reference voltage V_{MID}, the output signal 184 from comparator 181 will initially consist of narrow pulses as shown in FIG. 12b. This is because the voltage level of the saw-tooth waveform will only be higher than the voltage level of the reference voltage V_{MID} for relatively short periods of time. This will result in the NMOS transistor 185 being switched on for short periods of time, thereby allowing the voltage at node 133 to begin decaying at a relatively slow rate.

However, as the reference voltage V_{MID} begins to fall, the pulse widths of the output signal 184 from the comparator 181 will become wider, as shown in FIG. 12b. This in turn results in the NMOS transistor 185 becoming switched on for longer periods of time, which results in the voltage falling more rapidly. The control circuit therefore provides an acceleration effect that takes place due to the feedback arrangement.

From the above it can be seen that the comparator 181 generates a pulse width modulated (PWM) signal, in which the pulse widths are proportional to the voltage level of the reference voltage that is being controlled.

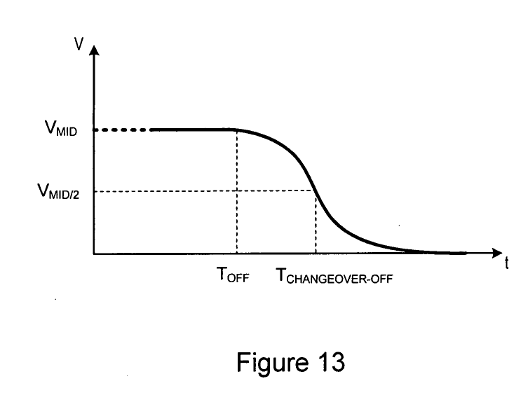

When V_{MID} falls below the voltage of the minima V_{CO,min} of the saw tooth waveform the transistor 185 will become turned hard-on continuously. Thus, in a similar manner to the power-up circuit of FIG. 5, the circuit of FIG. 11 operates in a first mode of operation during a first period, and a second mode of operation during a second period. In the first mode of operation the discharging of the capacitor 135 is controlled via the feedback path comprising the comparator 181, resistor 139 and transistor 185. In the second mode of operation the discharging of the capacitor is based on the RC time constant of resistor 139 in parallel with capacitor 135. And similarly, a smooth S-shape V_{MID} waveform will be generated, as illustrated in FIG. 13.

As with the start-up circuitry, care needs to taken to ensure operation will commence properly, despite circuit non-idealities such as offset voltages. The comparator may be designed to have a small consistent offset, or a switched current sink may be connected to V_{MID}, directly or via resistor 139, to start to pull V_{MID} down, or the comparison saw-tooth waveform may be offset in voltage. In each case an initial transient may occur, but this will only be small, since the additional offset or current need only be just sufficient to overcome any small non-idealities such as comparator input offsets.

Although not explicitly shown in FIG. 11, the discharging control circuit 180 can be arranged to be disabled during the second period of operation (i.e. at a suitable threshold voltage level V_{CHANGEOVER-OFF}), in a similar manner to that described above in FIGS. 8 to 10.

FIG. 13 shows how the reference voltage V_{MID} is discharged in a smooth and controlled manner at time T_{OFF} using the arrangement shown in FIG. 11, thus reducing audible “pop” sounds.

According to another embodiment, in addition to controlling the reference voltage generator circuit during power-up, the amplifier start-up apparatus is further adapted to control the reference voltage generator circuit during both power-up and power-down.

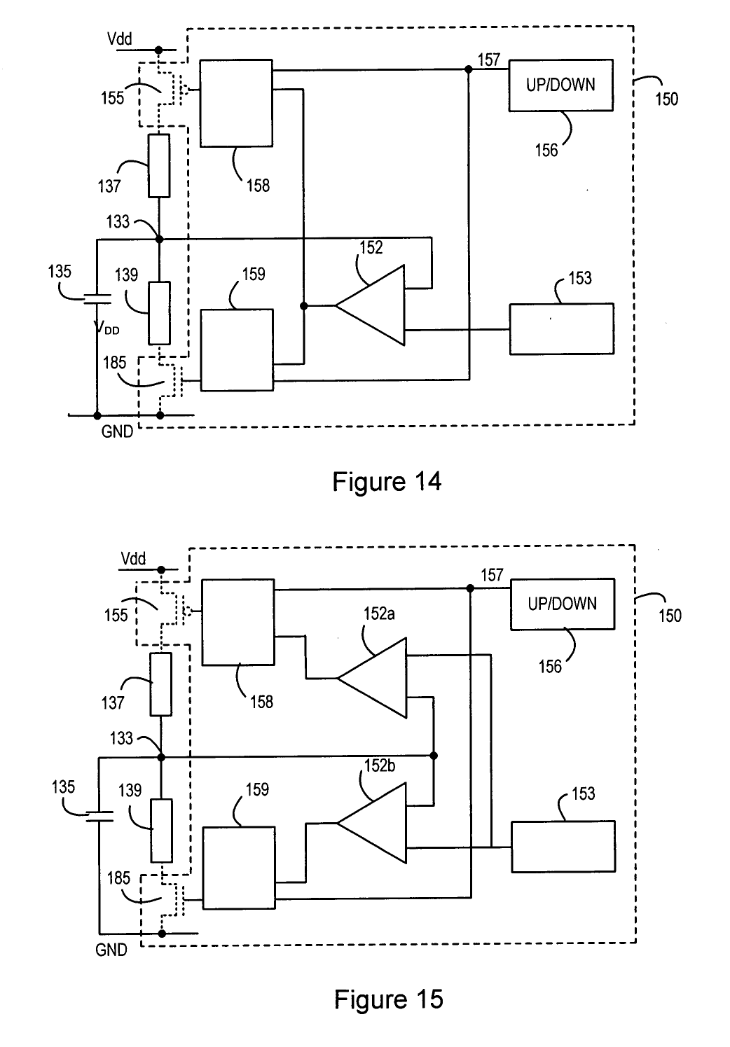

FIG. 14 shows an apparatus according to this aspect of the invention. The apparatus of FIG. 14 comprises a single comparator 152 for controlling the charging and discharging of the capacitor 135 during respective power-up and power-down operations. The output of the comparator 152 is provided to a first control circuit 158 which controls a first switch, e.g. transistor 155, during power-up, and a second control circuit 159 which controls a second switch, e.g. transistor 185, during power-down. It is noted that both the first control circuit 158 and the second control circuit 159 receive an Up/Down signal 157 from Up/Down control circuitry 156, for enabling the control circuits 158 and 159 to control the first and second transistors 155 and 185 in the appropriate manner during power-up and power-down. It will be appreciated by a person skilled in the art that the first and second control circuits 158 and 159 will comprise suitable circuitry for providing the appropriate control signals to transistors 155 and 185. For example, the first control circuit 158 can be configured to be enabled when the Up/Down signal 157 is high and disabled when the Up/Down signal 157 is low. Conversely, the second control circuit 159 can be configured to be disabled when the Up/Down signal 157 is high and enabled when the Up/Down signal 157 is low.

The first control circuit 158 and second control circuit 159 are also configured such that the PWM signals used to control the transistors 155 and 185 will comprise narrow pulses during the beginning of the power-up and power-down operations, respectively.

The arrangement shown in FIG. 14 has the advantage of only requiring a single comparator circuit 152 and a single waveform generator circuit 153 for controlling both the power-up and power-down operations, thereby saving layout space, cost and power consumption. The use of a single waveform generator circuit 153 will require some adaptation for such a combined power-up and power-down operation, for example configured to provide a comparison waveform between 0 v to VDD/4 during power-up and VDD/2 to VDD/4 during power-down, as will be appreciated by a person skilled in the art.

FIG. 15 shows an alternative arrangement according to a third aspect of the present invention. In FIG. 15 separate comparators 152a and 152b are provided for controlling the charging and discharging of the capacitor 135 during power-up and power-down operations, respectively. A single saw-tooth waveform generator 153 is provided for controlling the comparators 152a and 152b. The output from comparator 152a is provided to a first control circuit 158 for controlling the first switch, transistor 155. The output from comparator 152b is provided to a second control circuit 159 for controlling the second switch, transistor 185. The first and second control circuits 158 and 159 receive an Up/Down signal 157 from Up/Down control circuitry 156 for enabling the control circuits 158 and 159 to control the transistors 155 and 185 in the appropriate manner during power-up and power-down.

It is noted that the embodiments of FIGS. 14 and 15 can be adapted in a similar manner to FIGS. 8 and 10, such that the charging control circuit and/or discharging control circuit is disabled during a second period of operation, and other means provided for maintaining the charging or discharging operation.

The embodiments described above have the advantage of reducing and potentially preventing unwanted audio-band signals caused by non-smooth changes of V_{MID} from causing undesired audible artifacts during power up and power-down of the reference voltage generator circuit, while still allowing the reference voltage generator circuit to charge and discharge in a timely manner.

As mentioned above, it will be appreciated that other types of reference voltage generator circuits known to those skilled in the art could be used for generating the reference voltage, other than the potential divider circuit shown in the preferred embodiment.

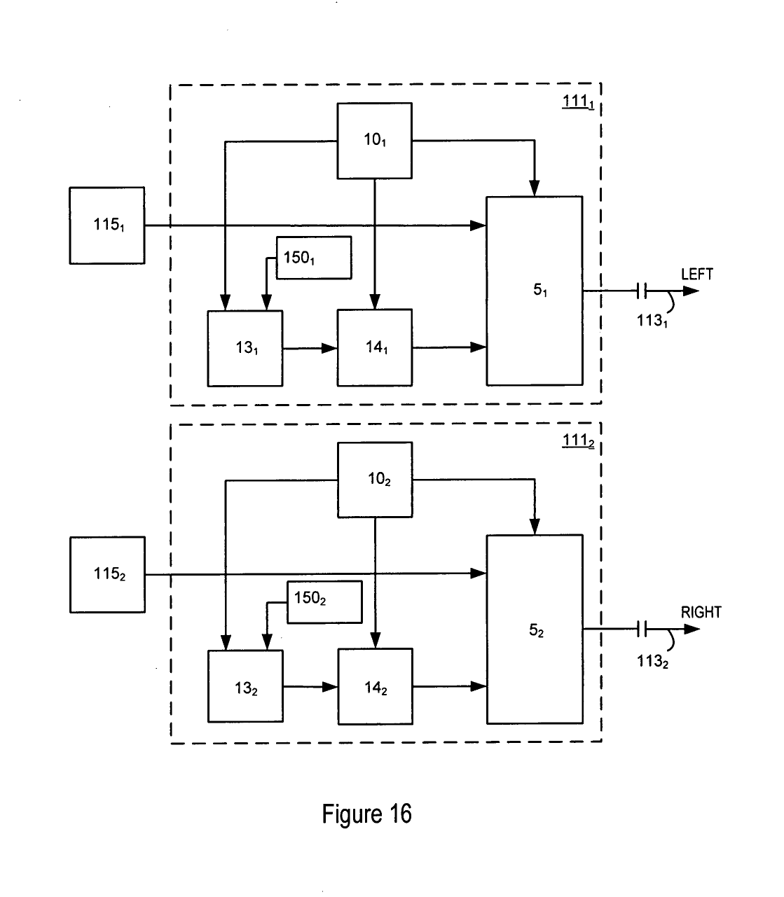

While the preferred embodiment has been described in relation to an amplifier circuit that produces one audio output signal, the invention is equally applicable with audio circuits that produce multiple audio output signals, for example a stereo system as shown in FIG. 16. In FIG. 16 the audio system comprises a first audio amplifier circuit 111₁ for producing a first audio output signal 113₁ (e.g. left output) from a first source 115₁, and a second audio amplifier circuit 111₂ for producing a second audio output signal 113₂ (e.g. right output) from a second source 115₂. FIG. 16 is shown as having separate controls 10₁ and 10₂ for audio amplifiers 5₁ and 5₂. However, it is noted that audio amplifiers 5₁ and 5₂ could operate from a single common control 10. Also, while FIG. 16 shows separate V_{MID} reference voltage generators 13₁ and 13₂, audio amplifiers 5₁ and 5₂ could operate from a single common reference voltage generator 13. It will be appreciated that a single or two amplifier power-up and power-down circuits according to the present invention will be employed depending upon whether the system of FIG. 16 comprises one or two V_{MID} reference voltage generators 13₁ and 13₂.

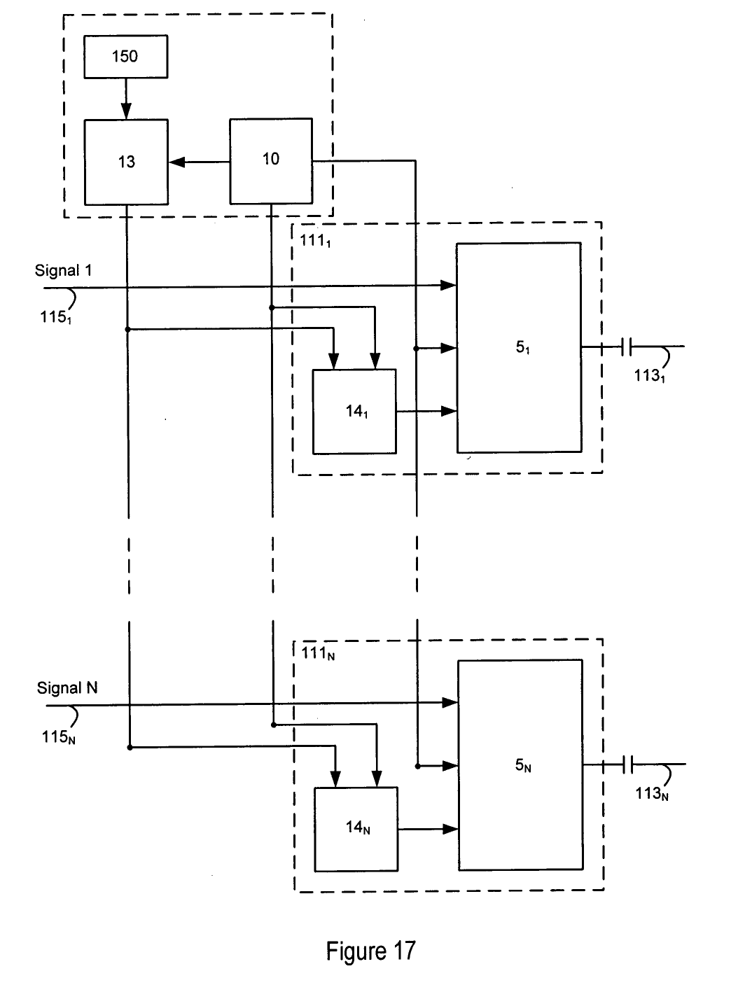

In addition, the invention can be used with an audio system as shown in FIG. 17, relating to a system having a plurality of outputs as used in home cinema applications (for example Dolby™ pro logic 5.1). A single V_{MID} reference voltage generator 13 and a single control logic 10 has been shown as controlling multiple audio amplifiers 5₁ to 5_{N}, each providing a separate output signal 113₁ to 113_{N} based on input signals 115₁ to 115_{N}. It is noted that the separate buffers 14₁ to 14_{N} in FIG. 17 could also be replaced by a single buffer 14.

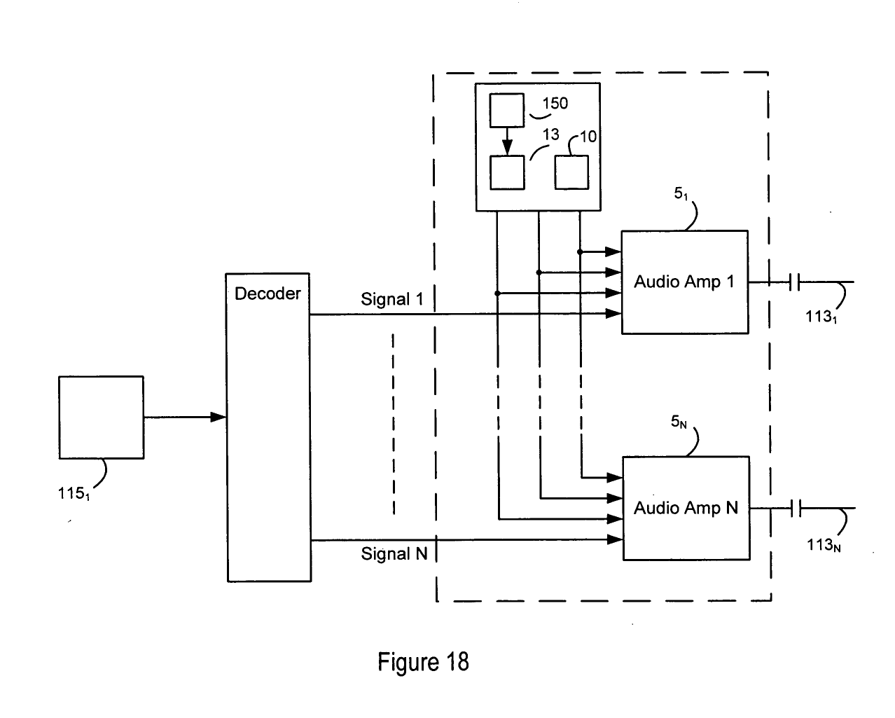

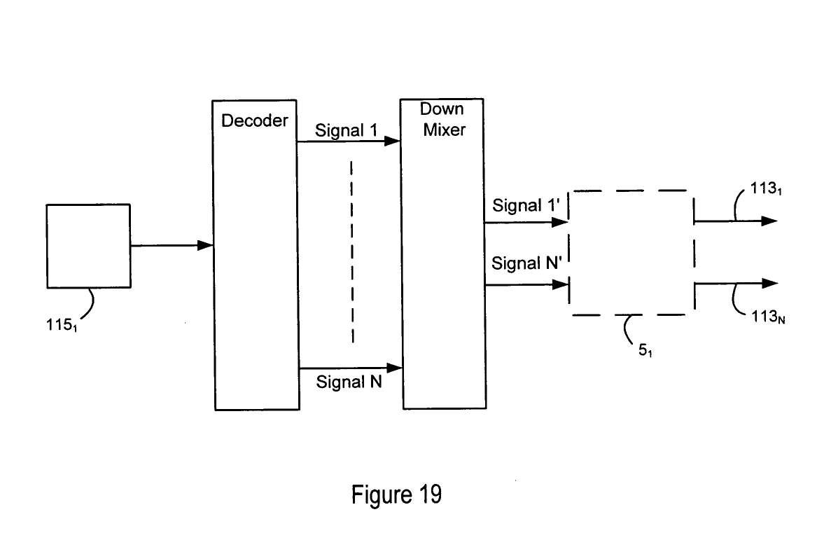

FIGS. 18 and 19 show further typical applications in which the invention can be used. FIG. 18 shows a system in which N input signals are shown as being derived from a Decoder, such as a Dolby™ Decoder, that is used to decode time multiplexed audio signals from a DVD, for example. FIG. 19 shows a system in which N signals from a decoder are fed into a Down Mixer such that signals 1 to N are mixed to form signals 1′ to N′ (where N′<N). For example, signals 1 to N may be the six signals associated with a home cinema system and signals 1′ to N′ may be left and right stereo signals which are used to produce stereo output signals 1′ and N′.

It will be appreciated by a person skilled in the art that the references to PMOS and NMOS transistors could be implemented by other switching devices, and in other configurations providing the same end result. For example, the PMOS switching device 155 of FIG. 5 could be replaced by an NMOS device, provided that the comparator 151 is adapted to provide a corresponding control signal. In other words, if the comparator 151 is configured to drive an NMOS transistor 155, then the output 154 of the comparator would be normally low, with the “narrow” pulses being narrow pulses corresponding to the output signal 154 going from low to high, as opposed to the narrow pulses shown in FIG. 6b. Similar alternatives apply to other switching devices of the preferred embodiments.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single element or other unit may fulfil the functions of several units recited in the claims. Any reference signs in the claims shall not be construed so as to limit their scope.

What is claimed is:

1. An amplifier start-up apparatus for reducing transient signals in an audio circuit comprising a reference voltage generator circuit for generating a reference voltage, the reference voltage generator circuit comprising a capacitor for maintaining the reference voltage at a desired level, the apparatus comprising:
a switching device connected between the capacitor and a supply voltage; and
a charging control circuit for controlling the operation of the switching device during power-up;
wherein the charging control circuit comprises circuitry for providing a pulsed signal for controlling the switching device, and hence the rate at which the capacitor is charged.

2. An apparatus as claimed in claim 1, wherein the charging control circuit is configured to operate in a first mode of operation during a first period, and a second mode of operation during a second period.

3. An apparatus as claimed in claim 2, wherein the charging control circuit is adapted to provide a pulse width modulated signal for controlling the switching device during the first period of operation.

4. An apparatus as claimed in claim 3, wherein the width of a pulse in the pulse width modulated signal is proportional to the level of the reference voltage being generated.

5. An apparatus as claimed in claim 3, wherein the charging control circuit is adapted to provide pulsed signals having narrow pulse widths during the initial stages of a charging operation, and adapted to increase the pulse widths during the charging operation.

6. An apparatus as claimed in claim 1, wherein the circuitry for providing the pulsed width modulated signal comprises a first comparator.

7. An apparatus as claimed in claim 6, wherein the first comparator is connected to receive a comparison waveform on a first input terminal, and the reference voltage that is being generated on a second input terminal.

8. An apparatus as claimed in claim 7, wherein the comparison waveform is a saw-tooth waveform.

9. An apparatus as claimed in claim 7, wherein the operation of the charging control circuit during the first period is based on a positive feedback path comprising the first comparator, the switching device and a first resistor device in the reference voltage generator circuit.

10. An apparatus as claimed in claim 7, wherein the operation of the charging control circuit during the second period is based on a RC time constant of the reference voltage generator circuit.

11. An apparatus as claimed in claim 2, wherein the charging control circuit is configured to be disabled during the second period of operation.

12. An apparatus as claimed in claim 11, further comprising changeover circuitry for controlling the switching device when the charging control circuit is disabled during the second period.

13. An apparatus as claimed in claim 12, wherein the changeover circuitry comprises a dedicated switching device for maintaining a charge on the capacitor when the charging control circuit is disabled during the second period.

14. An apparatus as claimed in claim 1, further comprising:
a second switching device for discharging the capacitor;
a discharging control circuit for controlling the operation of the second switching device during power-down;
wherein the discharging control circuit comprises circuitry for providing a pulsed signal for controlling the second switching device, and hence the rate at which the capacitor is discharged.

15. An apparatus as claimed in claims 14, wherein the first comparator is adapted to provide the pulsed signal to the second switching device.

16. An apparatus as claimed in claim 14, further comprising a second comparator for providing pulsed signals to the second switching device.

17. An apparatus as claimed in claim 14, wherein the discharging control circuit is adapted to operate in a first mode of operation during a first period of a discharging operation, and a second mode of operation during a second period of the discharging operation.

18. An apparatus as claimed in claim 17, wherein the discharging control circuit is adapted to provide a pulse width modulated signal for controlling the switching device during the first period of the discharging operation.

19. An apparatus as claimed in claim 17, wherein the discharging control circuit is adapted to discharge the capacitor during the second period of operation based on a RC time constant of the reference voltage generator circuit.

20. An apparatus as claimed in claim 1, wherein each switching device comprises a transistor.

21. An apparatus as claimed in claim 1, wherein the reference voltage generator circuit comprises a potential divider circuit for producing the reference signal, the potential divider circuit comprising first and second resistors connected in series between a power supply and a ground connection, and the capacitor connected between ground and a common node connecting the first and second resistors.

22. A method of reducing transient signals in an amplifier start-up apparatus for an audio circuit comprising a reference voltage generator circuit for generating a reference voltage, the reference voltage generator circuit comprising a capacitor for maintaining the reference voltage at a desired level, the method comprising the steps of:
providing a switching device between the capacitor and a supply voltage; and
controlling the operation of the switching device during power-up by providing a pulsed signal for controlling the switching device, and hence the rate at which the capacitor is charged.

23. A method as claimed in claim 22, further comprising the steps of configuring the charging control circuit to operate in a first mode of operation during a first period, and a second mode of operation during a second period.

24. A method as claimed in claim 22, further comprising the step of providing a comparator for generating the pulsed signal.

25. A method as claimed in claim 24, wherein the comparator receives a comparison waveform on a first input terminal, and the reference voltage that is being generated on a second input terminal.

26. A method as claimed in claim 25, wherein the comparison waveform is a saw-tooth waveform.

27. A method as claimed in claim 23, wherein the step of charging during the first period is based on a positive feedback path comprising the comparator, the switching device and a first resistor device in the reference voltage generator circuit.

28. A method as claimed in claim 23, wherein the step of charging during the second period is based on a RC time constant of the reference voltage generator circuit.

29. A method as claimed in claim 23, further comprising the step of disabling the charging control circuit during the second period of operation.

30. A method as claimed in claim 22, further comprising the steps of:
providing a second switching device for discharging the capacitor; and
controlling the operation of the second switching device during power-down by providing a pulsed signal for controlling the second switching device, and hence the rate at which the capacitor is discharged.

31. A method as claimed in claim 30, wherein the comparator used to control the first switching device is also used to provide a pulsed signal to the second switching device.

32. A method as claimed in claim 30, further comprising the step of providing a second comparator for providing pulsed signals to the second switching device.

33. An audio apparatus incorporating an amplifier start-up apparatus according to claim 1.

34. A portable audio apparatus incorporating an amplifier start-up apparatus according to claim 1.

35. A headphone amplifier incorporating an amplifier start-up apparatus or part thereof according to claim 1.

36. A headphone incorporating an amplifier start-up apparatus according to claim 1.

37. A communications apparatus incorporating an amplifier start-up apparatus according to claim 1.

38. An in-car audio apparatus incorporating an amplifier start-up apparatus according to claim 1.

39. A reference voltage signal for use in an audio circuit, the reference voltage signal configured to have an “S” type shape using the amplifier start-up apparatus according to claim 1.
